(19) United States
(12) Patent Application Publication
(10) Pub. No.: US 2016/0352847 A1
(43) Pub. Date: Dec. 1, 2016

(54) TECHNIQUES TO OPERATE AN EXPERIMENT OVER A COMPUTING NETWORK

(71) Applicant: Microsoft Technology Licensing, LLC, Redmond, WA (US)

(72) Inventors: Brian Jude Frasca, Clyde Hill, WA (US); Li-wei He, Bellevue, WA (US); Nils Henry Pohlmann, Seattle, WA (US); April Powan Kwong, Sammamish, WA (US); Yu Chen, Sammamish, WA (US); Ron Kohavi, Bellevue, WA (US); Hong Chang, Redmond, WA (US); Shaojie Deng, Bellevue, WA (US); Caleb Wayne Hug, Issaquah, WA (US); Garrett John Bronner, Bellevue, WA (US)

(73) Assignee: MICROSOFT TECHNOLOGY LICENSING, LLC, Redmond, WA (US)

(21) Appl. No.: 14/723,547

(22) Filed: May 28, 2015

(51) Int. Cl. H04L 29/08; H04L 12/26; G06F 17/30

(52) U.S. Cl. CPC H04L 67/22; G06F 17/30598; H04L 43/16

(57) ABSTRACT

Techniques to operate an experiment (online) over a computer network comprised of computing devices. The experiment may consist of a series of tests on experiment variants of a software application running on the computing devices of which each variant refers to a particular application version or implementation. These techniques may be configured into hardware operative to run such tests over the computer network by selecting one group or multiple groups of computing devices. Other embodiments are described and claimed.

### BACKGROUND

When evaluating experiments over a computer network (e.g., an online controlled experiment), a considerable number of computer device users are partitioned into two or more groups such that each group is assigned to an experiment variant. Often, the experiment variant refers to a specific implementation of an application and a typical experiment involves two groups assigned to two experiment variants—a control group and a treatment group. In this experiment, one group of computer device users executes one application implementation, another group executes another application implementation on their computer devices, and data generated by these groups is tested according to one test type. Most experiments involve multiple application implementations and multiple test types for each application implementation. Therefore, running the typical experiment consumes substantial quantities of computer resources and will require a skilled workforce and considerable capital to even start. When the experiment does not produce useful or relevant results, the above mentioned computer resources and capital will have been wasted and the skilled workforce will have been underutilized.

It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to operate an experiment over a computing network. Some embodiments are particularly directed to techniques to operate such an experiment over a computing network of computer devices for enhancement of online experimentation. In one embodiment, for example, an apparatus may comprise logic operative on the logic circuit to access information corresponding to experiment variants and a plurality of experimental units, process one or more retrospective evaluations of activity data generated by the plurality of experimental units to select a group of the experimental units for an experiment variant based upon impartiality criteria, and run the experiment variant for the selected group of the experimental units. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system to operate an experiment over a computer network.

FIG. 2 illustrates an embodiment of an operating environment for components of the system of FIG. 1.

FIG. 3 illustrates an embodiment of a selection process performed by the components of the system of FIG. 1.

FIG. 4 illustrates an embodiment of a timing diagram for an experiment according to the selection process of FIG. 3.

FIG. 5 illustrates an embodiment of a logic flow for the system of FIG. 1.

FIG. 6 illustrates an embodiment of a logic flow for a component of the system of FIG. 1.

FIG. 7 illustrates an embodiment of a logic flow for the selection process of FIG. 3.

FIG. 8 illustrates an embodiment of a computer network for the system of FIG. 1.

FIG. 9 illustrates an embodiment of a computing architecture.

FIG. 10 illustrates an embodiment of a communications architecture.

### DETAILED DESCRIPTION

Various embodiments are directed to operate an experiment over a computer network of computing devices, for example, by evaluating data generated by these devices and selecting a permutation of the computing devices (referred to as experimental units) that behave with little or no bias. Such a permutation is likely to result in meaningful experiment results. This permutation may partition the experimental units into groups that will minimize or, in some cases, eliminate any statistical bias for the experiment and hence, reduce false positives/negatives when running tests on the data generated by the devices of the computer network.

A typical experiment over the computer network provides an online experience of a software application and most likely involves a substantial number of computing devices running some implementation or version of the software application to test the usefulness of that implementation or version. Hence, each variant used in the experiment may include an application implementation with at least one differentiating feature, rendering that application implementation unique amongst other experiment variants. To efficiently test the variant, the experiment may engage in a statistical comparison between one group of devices running the variant and another group running another variant, such as a standard or control version. If it can be inferred from the statistical comparison that the two groups have different application experiences, such an inference could indicate that the differentiating feature significantly impacts application performance. However, if one or both groups produce data having a non-trivial statistical bias, the inference may be false and the entire experiment could potentially be wasted. Identifying groups with such a bias before the experiment prevents such wastage.

Various embodiments of the techniques described herein select a group of computing devices whose users operate their devices with little or no bias toward a certain behavior. These devices may be selected, according to some example embodiments, via an offline experiment known as a retrospective evaluation, which provides useful information regarding which computing device or devices produce activity data without the statistical bias towards abnormal activities. In some example embodiments, the retrospective evaluation involves searching a permutation (e.g., a random permutation) of users of the current application version and quantifying a statistical bias, if any, that is exhibited by one user's device or a group of user devices. Hence, the retrospective evaluation facilitates a meaningful comparison of groups of computing devices for selecting a balanced group of devices where the group, as a whole, is unbiased. The retrospective evaluation also facilitate the selection of one group over another group for being less impartial and furthermore, the selection of a set of groups (e.g., a pair of groups) where the groups are similar to each other with respect to impartiality.

In preparation for a current experiment, some example embodiments process a number of concurrent retrospective evaluations of the computing devices (i.e., experimental units) to select the group of devices for an experiment variant based upon at least some impartiality criteria. The retrospective evaluation generally involves leveraging data related to an application implementation or version already running on the device to enhance the current experiment, for example, by identifying impartial experimental units. As described herein, these impartial experimental units typically exhibit unbiased behavior when operating software applications and therefore, can be used to provide meaningful results when testing different features (e.g., variants) of the software application. The impartiality criteria generally define a mechanism to identify indicators of unbiased behavior from the experimental unit's activity data and to determine whether that experiment unit should be used to run the experiment variant in the experiment. One example implementation of the retrospective evaluation involves executing a process to generate a random permutation of the experimental units, assign those experimental units to groups of experimental units, and compute a score measuring bias between the groups in accordance with the impartiality criteria. As a result, the embodiments can improve affordability, scalability, modularity, extendibility, or interoperability for an operator, device or network.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

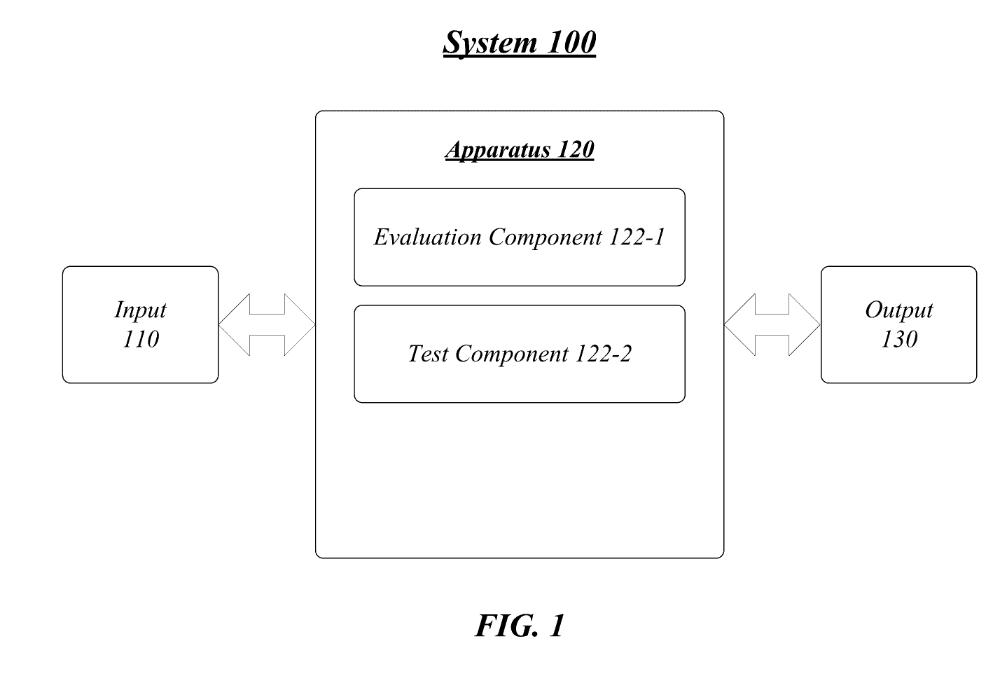

FIG. 1 illustrates a block diagram for a system 100. In one embodiment, the system 100 may comprise a computer-implemented system 100 having an apparatus 120 comprising one or more components 122-a. Although the system 100 shown in FIG. 1 has a limited number of elements in a certain topology, it may be appreciated that the system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

The system 100 may comprise the apparatus 120. The apparatus 120 may be generally arranged to operate an experiment over a computer network to test different implementations of an application. The apparatus 120 may connect via the computer network to a plurality of computing devices and may configure these devices to run one or more of the different application implementations.

Some example components of the apparatus 120 may include an evaluation component 122-1 and a test component 122-2. The evaluation component 122-1 may be generally arranged to process input 110 including information corresponding to one or more experiment variants in operation on the plurality of computing devices (which are referred to herein as “experimental units”). As described in the present disclosure, the evaluation component 122-1 may utilize the above mentioned information to select a group of the experimental units for testing an experiment variant of the experiment.

The test component 122-2 may be generally arranged to generate output 130 corresponding to running the experiment of which a portion provides each computing device user in the above mentioned group of the experimental units with an application experience associated with the experiment variant. According to some embodiments, the test component 122-2 executes computer code on each computing device to run the experiment variant on that device. This may be accomplished by stopping or turning off any interfering or competing features and routing data to the experiment variant. Alternatively, the test component 122-2 may execute computer code to run the experiment variant within the system 100 while serving data only to the group of the experiment units, for example, by configuring the apparatus 120 to direct traffic to and from a network address (e.g., an Internet Protocol (IP) address) associated with the computing devices in the computing devices.

Various embodiments of the apparatus 120 may include logic operative on the logic circuit to access the information corresponding to the experiment variants and the plurality of experimental units, process one or more retrospective evaluations of the plurality of experimental units to select the group of the experimental units for an experiment variant based upon impartiality criteria, and run the experiment variant for the selected group of the experimental units. The impartiality criteria generally define a mechanism to extract indicators of unbiased behavior from the experimental unit's activity data and to determine whether that experiment unit should be used to run the experiment variant for the experiment. The impartiality criteria may employ various metrics to compare the activity of different groups. The following is an incomplete list of metrics for the impartiality criteria. These generally cover user engagement and some may be application version/development team centric: web results page-click-rate, web page loading time including content pane loading time, time to success, a number of success per user, session success rate (SSR), quick back, revenue rate per user, a number of distinct queries, a number of queries per user or per session, an average use time, and so forth.

A retrospective evaluation generally involves leveraging data related to an application implementation or version already running on the experimental units to enhance a current experiment, for example, by identifying impartial experimental units. As described herein, these impartial experimental units typically exhibit unbiased behavior when operating software applications and therefore, can be used to provide meaningful results when testing different features (e.g., variants) of the software application. The impartiality criteria described above may be configured to identify indicators of a statistical bias in the experimental unit's activity data. One example implementation of the retrospective evaluation involves executing a process to generate a random permutation of the experimental units, assign those experimental units to groups of experimental units, and compute a score to measure bias, if any, between the groups in accordance with the impartiality criteria. Another example implementation of the retrospective evaluation involves executing a process to generate a random sample of the experimental units and compute a score corresponding to an overall impartiality of that sample.

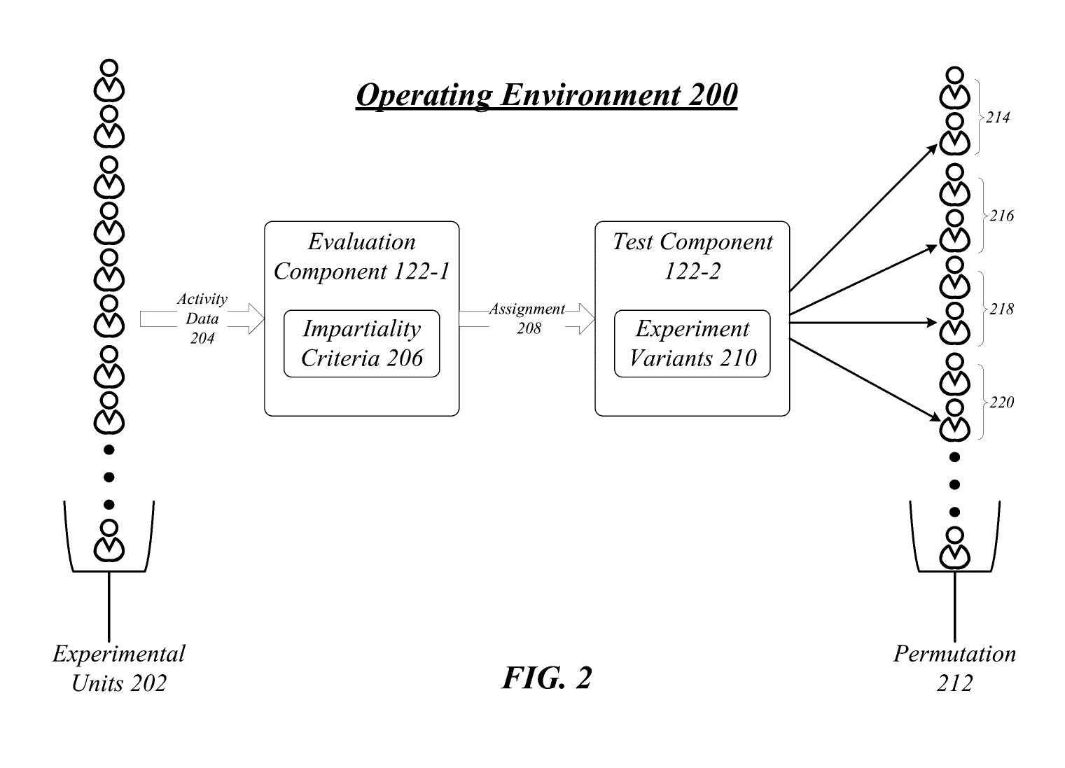

FIG. 2 illustrates an embodiment of an operating environment 200 for the system 100 of FIG. 1. As shown in FIG. 2, the operating environment 200 includes the evaluation component 122-1 and the test component 122-2 of the apparatus 120 of FIG. 1 and one or both of these components are communicably coupled to computing devices known as experimental units 202. These computing devices generate activity data 204 of which a portion may correspond to a device user's application experience, such as data describing interactions with interface elements (e.g., online advertisements in a search engine experience).

One example implementation of the activity data 204 provides various statistics to the evaluation component 122-1 and when compared to a set of metrics stored in impartiality criteria 206, the evaluation component 122-1 generates an assignment 208 between the experimental units 202 and experiment variants 210. The assignment 208 includes a permutation 212 of the experimental units 202 to minimize bias or reduce carryover effects. In some embodiments, partitioning that permutation 212 into groups and then pairing those groups based upon the impartiality criteria 206 results in pairs 214, 216, 218, and 220 of groups that have a highest (overall) retrospective score.

The evaluation component 122-1, as described herein, may select the above-mentioned groups for the assignment 208 by generating a randomized permutation of the experimental units 202 and processing the statistics in the activity data 204 that are associated with those experimental units 202 that are running a same experiment variant and receiving the same application experience. The randomized permutation may be divided evenly such that every K experimental units form a group. The evaluation component 122-1 may compare the activity data 204 of each of the pairs 214, 216, 218, and 220 in accordance with the impartiality criteria 206, for example, by performing a statistical comparison to determine whether there is a statistically significant bias between the groups and/or between one group and normal data. In some embodiments, different combinations of the groups are evaluated for impartiality. If activity data distributions for the current pairs 214, 216, 218, and 220 are projected to have a lowest statistical difference (e.g., highest p-values in an alpha/beta hypothesis test) between each pair's respective groups, the current randomized assignment of the experimental units 202 is selected for the experiment variants 210. If not, the evaluation component 122-1 evaluates another randomization of the experimental units 202 until an optimal permutation 212 is identified.

As an example, for groups comprising the pair 216, when compared to each other using the impartiality criteria 206, these groups have a lowest statistical difference with respect to their activity data 204. The pair 214 may comprise of groups of experimental units that have a next lowest statistical difference with respect to their activity data 204. Furthermore, the pairs 218 and 220 may comprise of groups of experimental units that have a next lowest statistical difference and fourth lowest statistical difference, respectively. It is appreciated that another example embodiment includes an alternative combination of these groups, such as when the alternative combination is equally biased or marginally less biased than the pairs 214, 216, 218, and 220. If new activity data indicates a change in impartiality, the groups may be rearranged into new pairs 214, 216, 218, and 220 such that the impartiality between the groups in each pair is minimized or eliminated. It also is appreciated that yet another example embodiment may generate a different permutation 212 of the experimental units 202, for example, when using alternative impartiality criteria 206.

Once that permutation 212 is selected, the test component 122-2 configures the computing devices in the experimental units 202 to run one of the experiment variants 210. As noted herein, these computing devices operate a particular version or implementation of an application. Therefore, configuring the computing devices may involve executing computer code on the computing devices to turn off certain features and/or turn on other features of the application in order for the experiment variant to run. In one example embodiment, the test component 122-2 assigns a control and a treatment to a pair amongst the pairs 214, 216, 218 and 220 such that one group in the pair runs the control and the other group runs the other treatment. The control may refer to a baseline or featureless application implementation and the treatment may refer to an implementation with a new or updated feature.

To illustrate one example embodiment of the operating environment 200, consider an experiment where the experimental units 202 are computing devices users of a current search engine application. The activity data 204, therefore, may record interactions between the user and the search engine application, such as search result clicks, advertisement clicks, search chains and/or the like. As an example, the activity data 204 may store a number of advertisement clicks over a given time period (e.g., four (4) clicks per day) and any revenue generated from these advertisement clicks. The activity data 204 may provide fine-grained details regarding the advertisement clicks, such as advertisement type and revenue generated per user or per click. In order to test a new feature that displays more advertisements per search engine results page than the current search engine application, the evaluation component 122-1 partitions the experimental units 202 into groups that are balanced with respect to a statistical bias. Thus, the groups of experimental units 202, when taken together, have an overall statistical bias that is trivial or non-existent; and in the context of this experiment, there should no more than a trivial difference between the groups in terms of revenue generated and the number of advertisement clicks.

In order to identify such groups, the evaluation component 122-1 may perform a retrospective evaluation to generate a random permutation of the computing devices, partition that permutation to assign those devices to groups, and compute a score measuring statistical bias within groups and between the groups in accordance with the impartiality criteria 206. The retrospective evaluation may referred to as an offline or retrospective experiment that includes a statistical comparison (e.g., an alpha/alpha hypothesis test) to determine if the difference(s) between two groups is/are statistically significant, for instance, if a statistical (e.g., a mean) difference between the revenue generated by the users in both groups exceeds a significance threshold (e.g., a significance level (alpha) of 0.05) stored in the impartiality criteria 206. This may occur when a probability of observing such a revenue difference is low (e.g., a low p-value in hypothesis testing). If, however, the difference does not exceed the threshold and the statistical difference is low, the groups are acceptable candidates for the experiment. This may occur when a probability of observing such a revenue difference is high (e.g., a high p-value in hypothesis testing). Otherwise, if the difference does exceed the significance threshold, at least one group may be biased towards a particular behavior.

The evaluation component 122-1 may perform another statistical comparison on the activity data 204 in accordance with a metric for evaluating the number of advertisement clicks from each of the above mentioned groups. The impartiality criteria 206 may prescribe a different significance threshold (e.g., alpha in hypothesis testing) for this metric than the threshold prescribed for the revenue generated metric. Furthermore, this metric may analyze each group's number of advertisement clicks to compute an average click rate per day value and compare that rate to an average click rate for the current search engine application to determine whether the difference between click rates is significant if that difference exceeds a difference prescribed in the impartiality criteria 206.

In some embodiments, the evaluation component 122-1 proceeds to perform a retrospective evaluation on a number of different permutations of the experimental units 202 in order to identify the permutation 212 where the groups have a strong likelihood of producing experiment results without a statistical bias. In some embodiments, a specific number of different permutations to evaluate during the retrospective evaluation may be determined by the evaluation component 122-1 based upon the complexity of the experiment, for example, in terms of a number of features to test, a size in bytes of the search engine application, and a number of metrics to use. Once an appropriate set of groups is identified, the test component 122-2 distributes the new feature to some (e.g., half) of these groups for execution, allowing the remaining experimental units to continue using the current search engine application, and operates the experiment to determine whether displaying more advertisements alongside search engine results will generate more revenue without a noticeable decrease in customer satisfaction and/or performance.

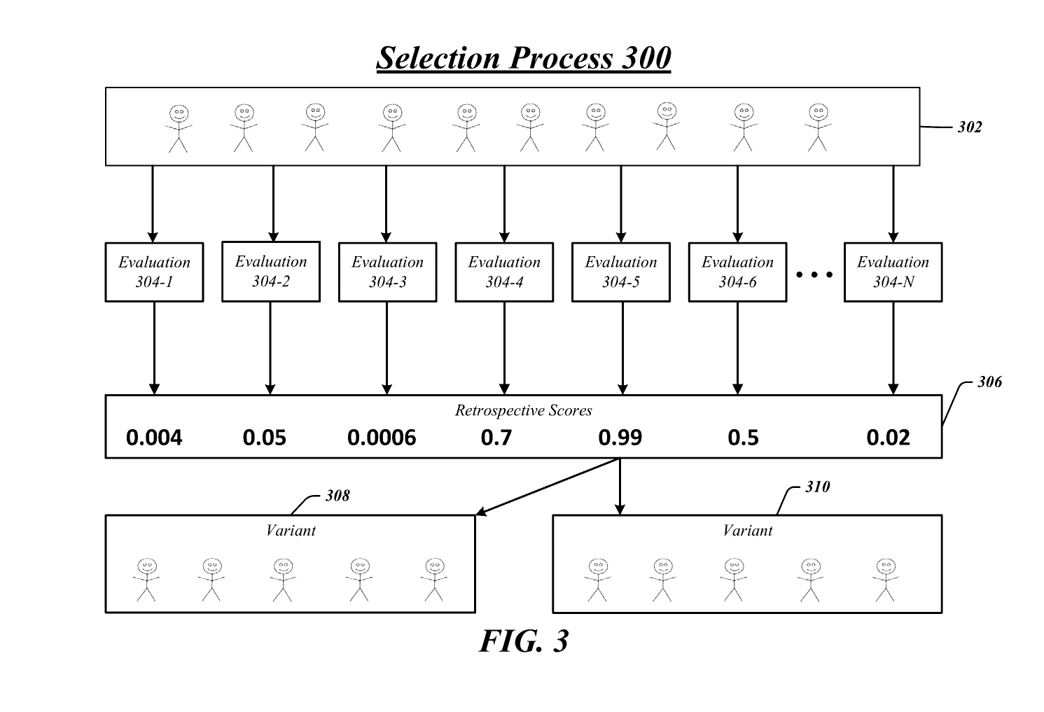

FIG. 3 illustrates an embodiment of a selection process 300 performed by the apparatus 120 of FIG. 1. In one embodiment, the evaluation component 122-1 and/or the test component 122-2 of the apparatus 120 may perform at least a portion of the selection process 300 described herein. It is appreciated that a number of the experimental units 302 used in a typical experiment most likely will exceed the number of reference symbols depicted in FIG. 3 and that such depictions are used for brevity and may represent considerably larger numbers of computing devices over a computer network.

One example implementation of the selection process 300 commences by processing information corresponding to the experimental units 302. This information may include information describing different variants used in the experiment, such as a control and one or more treatments. After assessing a complexity of the experiment, in some embodiments, the selection process 300 determines an appropriate breadth to search for an optimal or near-optimal permutation of the experimental units 302 that minimizes carryover effects and reduces false positives.

This may involve limiting a number of retrospective evaluations 304-N to a specific number N. This limit also operates to restrict the number of permutations being evaluated during the retrospective evaluations 304-N such that computing resources are not consumed while searching for a permutation with marginally less impartiality. Some example embodiments generate a different randomized permutation for each retrospective evaluation 304-a. Alternative embodiments may generate a non-random permutation or a pseudo-random permutation using other search techniques, such as branch pruning and/or prediction modeling. One alternative embodiment may confine a scope of the search to a specific set of permutations.

Each of the retrospective evaluations 304-N produces a retrospective score to quantify that evaluation's corresponding permutation's goodness of fit to the impartiality criteria. Each score may further indicate a probability that the corresponding permutation is the optimal permutation amongst all possible permutations of the experimental units 302. A highest retrospective score amongst retrospective scores 306 implies a permutation lacking a noticeable bias against the experiment variants, for example, because a pair of groups of experimental units 302 have no discernable difference between them. Therefore, an assignment between a first group of units to a variant 308 and a second group of units to a variant 310 most likely will produce impartial experiment results. As an alternative, the retrospective scores 302 may be represented qualitatively in terms of “satisfactory”, “fair”, “balanced,” “biased”, “great” and/or the like.

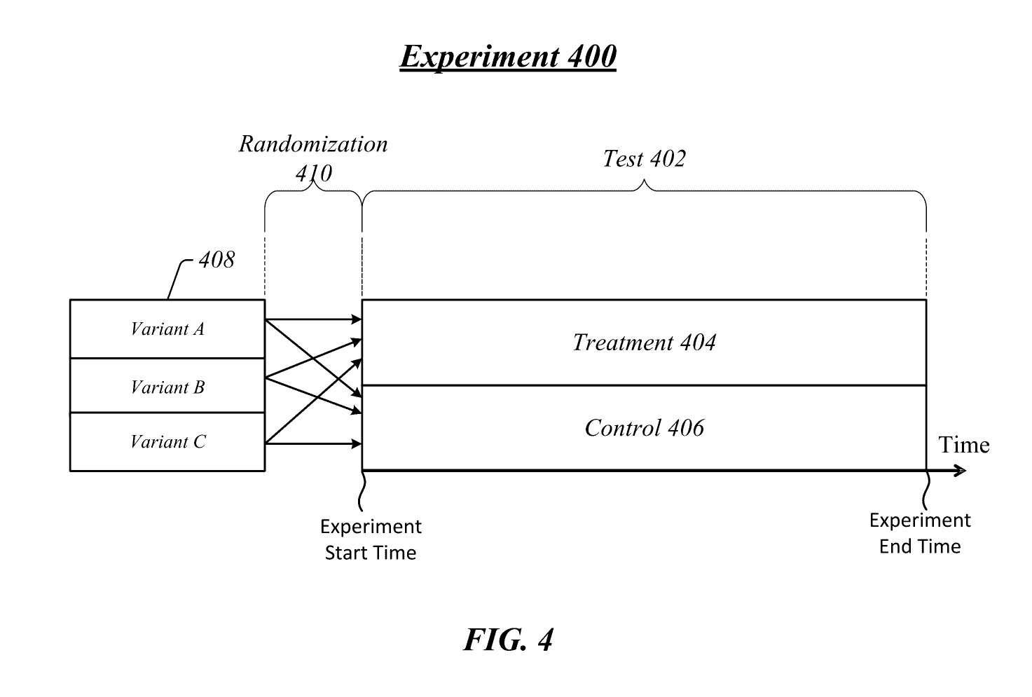

FIG. 4 illustrates, in a timing diagram, an embodiment of an experiment 400 according to the selection process 300 of FIG. 3. The experiment 400 may be configured according to one or more experiment types. As noted herein, various embodiments may run the experiment 400 as a statistical comparison of data corresponding to experiment variants that are executed on computing devices in a computer network. The statistical comparison may include a type of statistical test 402 between experimental units assigned to a treatment 404 and experimental units assigned to a control 406. An example implementation of the test 402 utilizes statistical hypothesis testing where the treatment 404 is an alternative hypothesis for the control 406 (i.e., a null hypothesis). If a statistical difference between measurements associated with the treatment 404 and the control 406 exceeds a threshold level, the statistical difference may be statistically significant and warrant a rejection of the control 406 as the null hypothesis.

Because the control 406 is in operation at the experimental units, groups of experimental units already generate activity data corresponding to the control 406; and by comparing one group's activity data with another group's activity data, it can be determined whether or not these groups of experimental units operate in a similar manner and exhibit impartial online behavior. To minimize or reduce statistical errors and bias in the experiment 400, a pair of groups of experimental units that produces substantially impartial experiment results may be selected before experiment start time.

In some example embodiments, the pair of groups of experimental units may be selected from computing devices that have not been a part of a prior experiment while, in other embodiments, the groups in the pair are comprised of computing devices that recently were used as experimental units for other experiment variants 408. To mitigate carry-over effects resulting from a previous assignment to the other experiment variants 408, one example technique generates an improved permutation of the experimental units such that some experimental units are (e.g., randomly) arranged into different groups. Therefore, if a group had a bad experience with one experiment variant, that group does not carry over that experience into the experiment 400.

In some example embodiments, the experimental units from different experiment variants 408 (depicted as “Variant A”, “Variant B”, and “Variant “C”) may undergo randomization 410 where these units are arranged into a random ordering. Since these experimental units previously were randomized during an initial assignment to these variants, it may be more appropriate to refer to the randomization 410 as a re-randomization. The experiment 400 may be configured to run tests on an application such that each experiment variant 408 refers to a specific application implementation where one or more features are different from other implementations.

To illustrate carry-over effect mitigation, consider an example where the experimental units that experience Variant A may be frustrated with that application implementation's performance, for example, a performance caused by that application's buggy feature. If those experimental units were assigned to the treatment 404, results of the experiment 400 may be skewed towards disliking the treatment 404 feature because of bias related to the frustration of Variant A. Instead of reassigning the entire group, the experimental units are randomly reordered such that some units are assigned into different groups, which substantially reduces the bias. As a result, when an unbiased group of experimental units operates the treatment 404, data generated for the experiment 400 is impartial and useful in judging the application implementation's performance.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

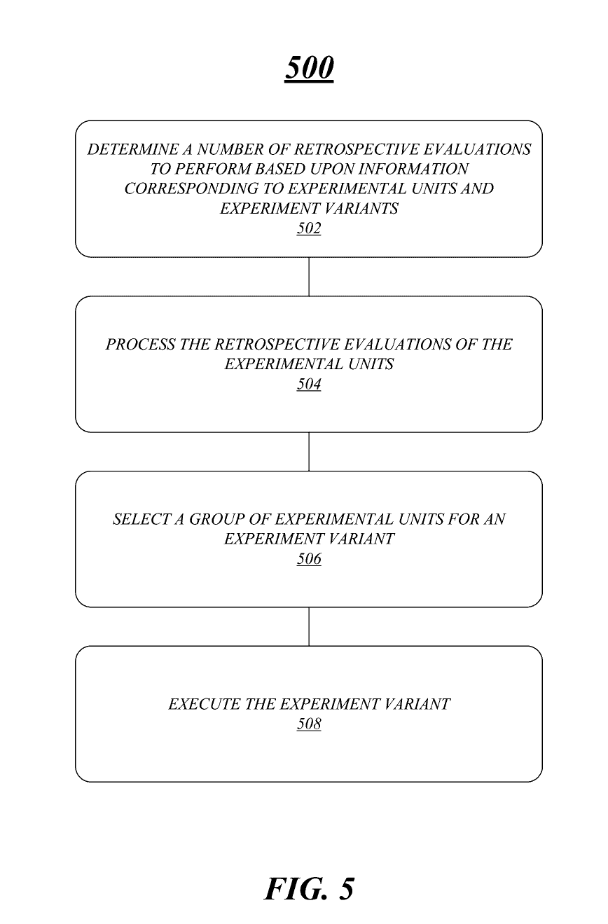

FIG. 5 illustrates one embodiment of a logic flow 500 for the system 100 of FIG. 1. The logic flow 500 may be representative of some or all of the operations executed by one or more embodiments described herein.

In the illustrated embodiment shown in FIG. 5, the logic flow 500 commences at block 502 at which the logic flow 500 may determine a number of retrospective evaluations to perform based upon information corresponding to experimental units and experiment variants. As described herein, such information describes an online experiment (e.g., the experiment 400 of FIG. 4) over a computer network to test the experiment variants' performance on a computing device. According to one example embodiment, the logic flow 500 uses this information to determine a complexity of the experiment and based upon that complexity, determines a limit on the number of retrospective evaluations to perform.

The logic flow 500 may process the retrospective evaluations of the experimental units at block 504. For example, each retrospective evaluation may generate a random permutation of the experimental units and the logic flow 500 computes a score for each retrospective evaluation to indicate a goodness of fit to impartiality criteria for that random permutation. The impartiality criteria may comprise of a set of metrics that when applied to activity data generated by the experimental units, produces a score to quantify a statistical bias in the random permutation of the experimental units.

The logic flow 500 may select a group of experimental units for an experiment variant based upon the one or more retrospective evaluations at block 506. The retrospective evaluation provides insight into each experimental unit's past activity data, including activity data associated with a different experiment variant such as an experiment control to which the experiment variant (i.e., treatment) is tested. For example, the logic flow 500 may identify, from the activity data associated with the different experiment variant such as the experiment control, those experimental units that, based in part on past behavior, are projected to react to the experiment variant without bias. The group of these experimental units, when given the experiment variant to run, produces impartial and useful experiment results. It is appreciated that a group of experimental units to execute the experiment control is available to operate the experiment.

The logic flow 500 may execute the experiment variant on the selected group of experiment units at block 508. For example, while operating the experiment over the computer network, the logic flow 500 monitors the experimental units for data associated with running the experiment variant and the experiment control. After simultaneously running both the experiment variant and the experiment control on their respective groups of experimental units, the logic flow 500 performs a statistical test on the monitored data to determine whether the experiment variant correlates to a change in the application experience. If a (statistical) difference between the monitored data for the experiment variant and the experiment control is statistically significant, the experiment variant may cause that difference. If the difference relates to a positive effect on the application experience, the experiment variant may be incorporated into the application to the benefit of the application user population. The embodiments are not limited to this example.

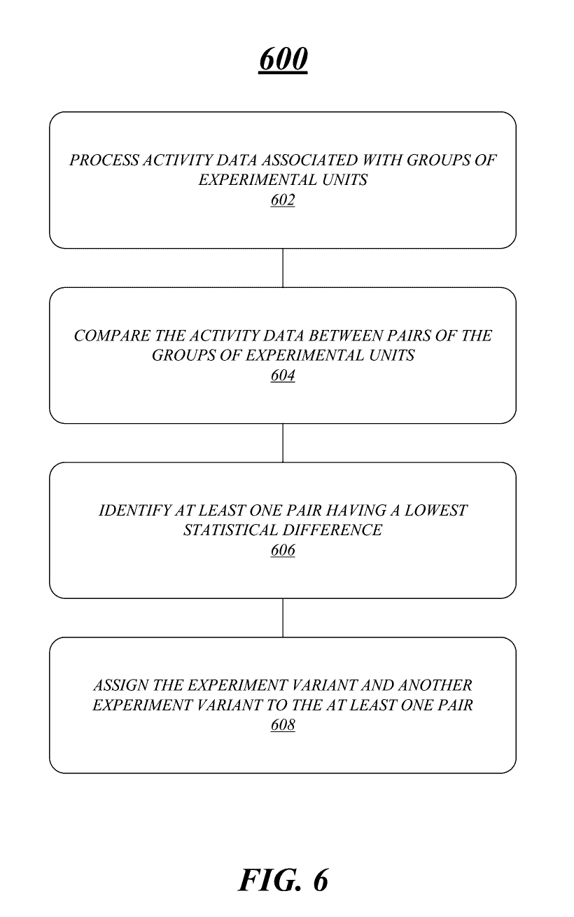

FIG. 6 illustrates one embodiment of a logic flow 600 for the components of FIG. 2. The logic flow 600 may be representative of some or all of the operations executed by one or more embodiments described herein.

In the illustrated embodiment shown in FIG. 6, the logic flow 600 commences at block 602 where the logic flow 600 processes activity data associated with groups of experimental units. In some embodiments, the activity data may describe an application experience including interactions between a computing device user and a software application configured to provide that user with the application experience. The software application may be an online application comprised of a set of computer code components located throughout the computer network. For instance, the software application may be a search engine in operation over a set of hardware/software components including a client component, a server component, and one or more intermediary components.

The logic flow 600 may compare the activity data between pairs of the groups of experimental units at block 604. The logic flow 600 may execute this comparison at block 604 to perform a retrospective evaluation of the experimental units with respect to each unit's likelihood for unbiased behavior in the current experiment. In some example embodiments, the retrospective evaluation may search current users of the above mentioned search engine for useful information in determining whether to select a particular group for an experiment on a different search engine implementation (e.g., a search engine with an updated feature). For example, the logic flow 600 performs a statistical test (e.g., sometimes known as an Alpha/Alpha hypothesis test) to determine how well the groups correlate to each other by comparing corresponding activity data points between groups and aggregating the differences into a value which may be referred to a statistical difference. In some embodiments, the logic flow 600 further compares the corresponding activity data points to impartiality criteria to adjust the statistical difference and compute a score (e.g., a retrospective score) indicative of the groups' past behavior when interacting with the current search engine implementation and that groups' expected bias (or lack thereof) when testing an updated search engine implementation.

The logic flow 600 may identify at least one pair having a lowest statistical difference at block 606. For example, amongst the pairs of experimental unit groups, one pair should have a lowest statistical difference and one or more pairs should, in aggregation, have a lowest overall statistical difference. The logic flow 600 may assign the experiment variant and another experiment variant to at least one pair of groups of the experimental units at block 608 such that one group in each pair is used to run the experiment variant and another group is used to run the other experiment variant. The at least one pair may be used in the experiment to test the experiment variant to see if that variant causes a statistically significant change in an average user's perception of the application's performance, for example, by comparing the current search engine to the updated search engine. The embodiments are not limited to this example.

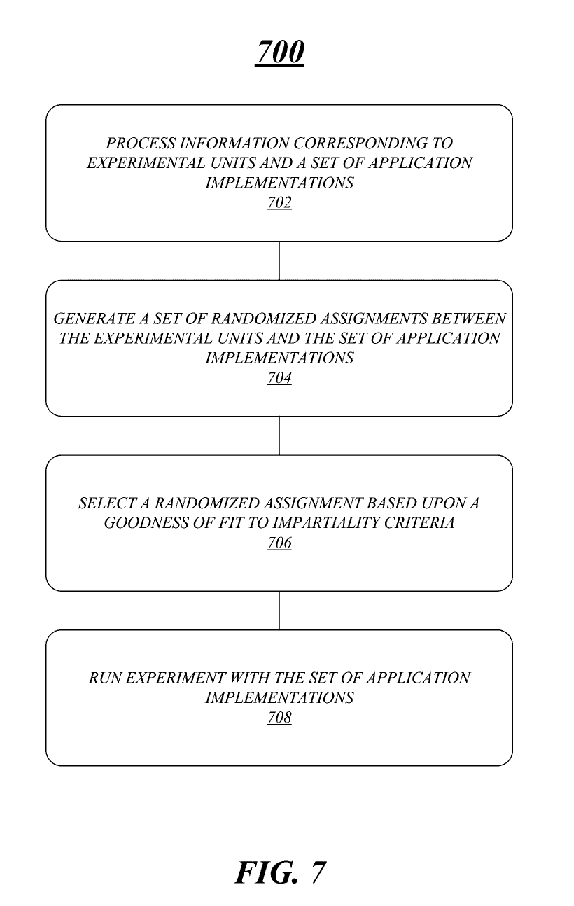

FIG. 7 illustrates one embodiment of a logic flow 700 for the selection process of FIG. 3. The logic flow 700 may be representative of some or all of the operations executed by one or more embodiments described herein.

In the illustrated embodiment shown in FIG. 7, the logic flow 700 commences at block 702 where the logic flow 700 process information corresponding to experimental units and a set of application implementations. As described herein, such information may describe various details regarding an experiment, such as data describing the experiment's complexity, activity data for each application implementation running on an experimental unit and so forth.

The logic flow 700 may generate a set of randomized assignments between the experimental units and the set of application implementations at block 704. Each randomized assignment, for example, may include an ordering (e.g., a random ordering) of the experimental units into groups of which each pair of group is designated to test a particular application implementation. In one example embodiment, one group of experimental units is configured to run the particular application implementation and another group is configured to run a current or standard application implementation (e.g., an experiment control) such the activity data corresponding to the particular application implementation can be compared against the other group's activity data. A deviation between the groups' activity data that exceeds a pre-defined threshold level may be considered statistically significant and therefore, the particular application implementation should be studied further when updating application features. As some examples, the particular application implementation may provide an improvement to an existing feature or a new feature or highlight a potential bug in the current or standard implementation.

The logic flow 700 may select a randomized assignment based upon a goodness of fit of that randomized assignment to the impartiality criteria at block 706. For example, the logic flow 700 may determine an appropriate combination of pairs to maximize impartiality and reduce bias in the experiment. As described herein, the impartiality criteria includes one or more metrics of assessing the randomized assignment's likelihood of providing unbiased experiment results. The logic flow 700 quantifies the goodness of fit by computing a score in accordance with the metrics in the impartiality criteria. If the groups in the randomized assignment have little or no bias in their previous application experience (when compared to each other), the impartiality criteria should produce a high score. If, on the other hand, the groups' activity data indicates substantial differences between groups, there may be at least some statistical bias in the experiment results and the impartiality criteria should produce a low score representative thereof. This may occur when the activity data of a few outliers is egregiously biased and skews an entire group's activity data towards the statistical bias. Once a best or optimal randomized assignment is identified, the logic flow 700 may run the experiment with the set of application implementations at block 708. The embodiments are not limited to this example.

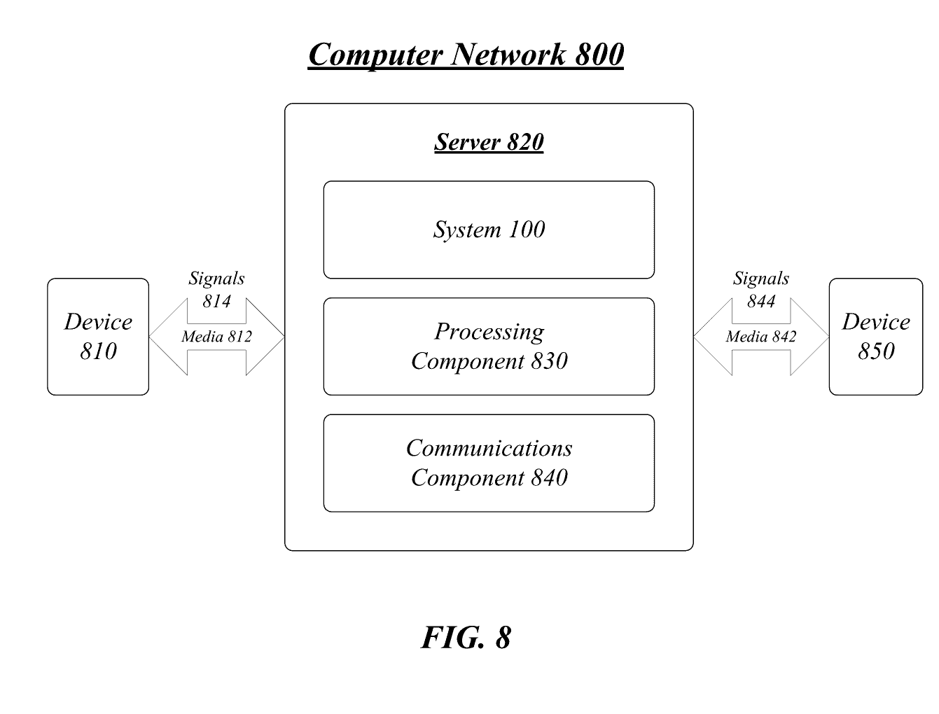

FIG. 8 illustrates an embodiment of a computer network 800 for the system of FIG. 1. FIG. 8 may illustrate a block diagram of the computer network 800 such the computer network 800 operates as a centralized environment for implementing the system 100 of FIG. 1. The computer network 800 may implement some or all of the structure and/or operations for the system 100 in a single computing entity, such as entirely within a single server 820.

The server 820 may comprise any electronic device capable of receiving, processing, and sending information for the system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The server 820 may execute processing operations or logic for the system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The server 820 may execute communications operations or logic for the system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The server 820 may communicate with other devices 810, 850 over a communications media 812, 842, respectively, using communications signals 814, 844, respectively, via the communications component 840. The devices 810, 850 may be internal or external to the server 820 as desired for a given implementation.

In some example embodiments, the server 820 (which may be referred to as an online experimentation server or apparatus) is configured to operate experiments over the computer network 800 by executing and/or monitoring different software applications running on the devices 810, 850 and, over time, testing various features for the different software applications. To reduce carry-over effects and bias amongst the device users and/or to improve experiment results, the server 820 selects the devices 810, 850 for their impartiality in past application experiences. The server 820 may select the devices 810 as one group and the devices 850 for another group in a pair that is configured to test a particular application implementation or version. As described herein, the devices 810 may run the particular application implementation while the devices 850 may run a control implementation. For a next experiment, the server 820 may change a hash seed and produce a different randomization (e.g., a re-randomization) of the devices 810, 850.

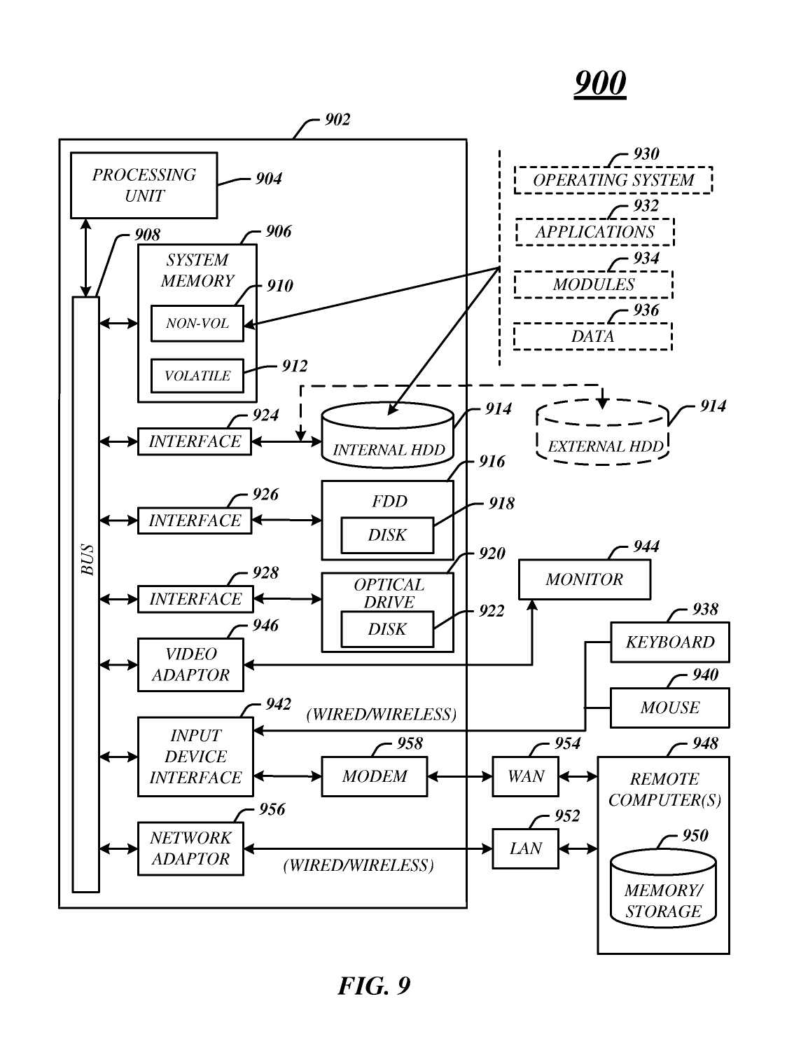

FIG. 9 illustrates an embodiment of an exemplary computing architecture 900 suitable for implementing various embodiments as previously described. In one embodiment, the computing architecture 900 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 904.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 900 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 100.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.9 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.9x (a, b, g, n, etc.) to provide secure, reliable, fast wireless connectivity. A Wi-Fi network can be used to connect computers to each other, to the Internet, and to wire networks (which use IEEE 802.3-related media and functions).

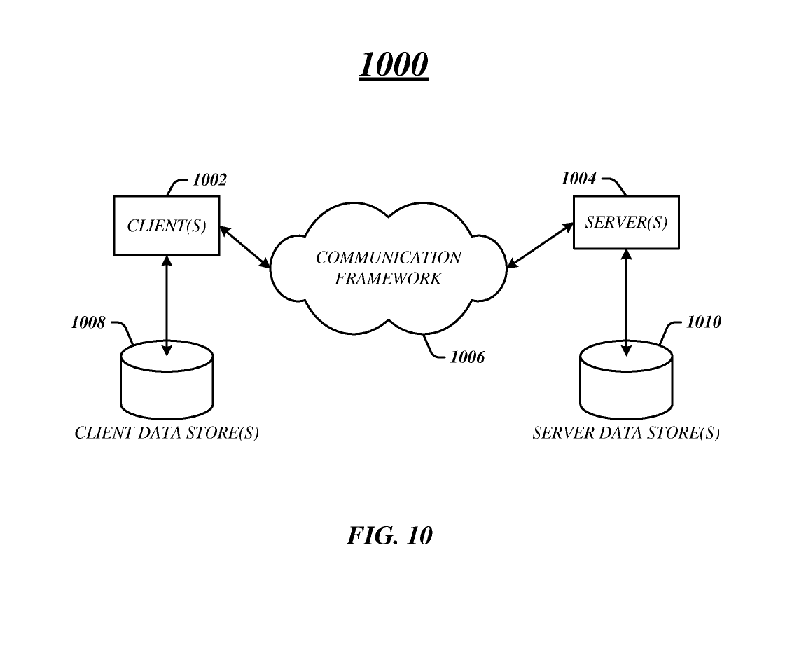

FIG. 10 illustrates a block diagram of an exemplary communications architecture 1000 suitable for implementing various embodiments as previously described. The communications architecture 1000 includes various common communications elements, such as a transmitter, receiver, transceiver, radio, network interface, baseband processor, antenna, amplifiers, filters, power supplies, and so forth. The embodiments, however, are not limited to implementation by the communications architecture 1000.

As shown in FIG. 10, the communications architecture 1000 comprises includes one or more clients 1002 and servers 1004. The clients 1002 may implement the client device 910. The servers 1004 may implement the server device 950. The clients 1002 and the servers 1004 are operatively connected to one or more respective client data stores 1008 and server data stores 1010 that can be employed to store information local to the respective clients 1002 and servers 1004, such as cookies and/or associated contextual information.

The clients 1002 and the servers 1004 may communicate information between each other using a communication framework 1006. The communications framework 1006 may implement any well-known communications techniques and protocols. The communications framework 1006 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1006 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11 a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1002 and the servers 1004. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic circuit; and
logic operative on the logic circuit to access information corresponding to experiment variants and a plurality of experimental units, process one or more retrospective evaluations of the plurality of experimental units to select a group of the experimental units for an experiment variant based upon impartiality criteria, and execute the experiment variant on the selected group of the experimental units.

2. The apparatus of claim 1, wherein the logic further operative to evaluate activity data of each experimental unit in the group of experimental units to determine a goodness of fit to the impartiality criteria.

3. The apparatus of claim 1, wherein the logic further operative to generate an optimal assignment of the experimental units to the experiment variants.

4. The apparatus of claim 1, wherein the logic is further operative to perform a statistical comparison between two or more groups of experimental units based upon activity data corresponding to the experiment variant.

5. The apparatus of claim 1, wherein the logic is further operative to select a number of the retrospective evaluations to perform based upon the information.

6. The apparatus of claim 1, wherein the logic is further operative to identify two or more groups of experimental units having a lowest statistical difference according to the impartiality criteria.

7. The apparatus of claim 1, wherein the logic is further operative to generate a random ordering of the plurality of experimental units, partition the random ordering into groups of experimental units, and execute a statistical comparison between the groups of experimental units.

8. The apparatus of claim 1, wherein the logic is further operative to randomize the plurality of experimental units after running the experiment variant, partition the randomized plurality of experimental units into groups of experimental units, and execute a statistical comparison between the groups of experimental units to select another group of experimental units for the experiment variant or another experiment variant.

9. The apparatus of claim 1, wherein the logic is further operative to compare activity data of each experimental unit in a first group of experimental units to activity data of another group of experimental units according to the impartiality criteria.

10. A method, comprising:
processing information corresponding to a plurality of experimental units and a set of application implementations;
generating a set of randomized assignments between the plurality of experimental units and the set of application implementations;
selecting a randomized assignment from the set of randomized assignments based upon a goodness of fit to impartiality criteria; and
running the set of application implementations according to the randomized assignment of the experimental units.

11. The method of claim 10 further comprising selecting the random assignment having a lowest statistical difference between groups of the experimental units.

12. The method of claim 11 further comprising processing activity data corresponding to the groups of experimental units and an application implementation of the set of application implementations.

13. The method of claim 12 further comprising executing a statistical comparison between a group of experimental units and another group of experimental units.

14. A system, comprising
an evaluation component operative to process activity data associated with groups of experimental units that are running an experiment variant, compare the activity data between pairs of the groups of the experimental units to identify at least one pair having a lowest statistical difference, and assign the experiment variant and another experiment variant to the at least one pair of the groups of the experimental units; and
a test component operative to configure the experiment variant or the other experiment variant to execute on each experimental unit of the at least one pair.

15. The system of claim 14, wherein the evaluation component is further operative to compare the activity data corresponding to an experiment control running on a first group of experimental units and a second group of experimental units.

16. The system of claim 15, wherein the evaluation component is further operative to select the first group of experimental units or the second group of experimental units for an experiment treatment or to compare the activity data of the first group of experimental units or the second group of experimental units to the activity data of a third group of experimental units.

17. The system of claim 14, wherein the evaluation component is further operative to randomize a plurality of the experimental units to generate new groups of the experimental units.

18. The system of claim 14, wherein the evaluation component is further operative to execute a statistical comparison between a first group of experimental units and a second group of experimental units in accordance with impartiality criteria.

19. The system of claim 14, wherein the evaluation component is further operative to process the activity data associated with the experiment variant comprising a feature-less application implementation.

20. The system of claim 14, wherein the evaluation component is further operative to identify two or more of the groups of experimental units having a confidence statistic that exceeds a significance threshold.
